(19) United States
(12) Patent Application Publication
(10) Pub. No.: US 2008/0319784 A1
(43) Pub. Date: Dec. 25, 2008

(54) Online health consultation

(76) Inventor: Haniel Cordero, Moca, PR (US)

Correspondence Address: Haniel Cordero Nieves, PO Box 1189, Moca, PR, 00676, US

(21) Appl. No.: 11/819,111

(22) Filed: Jun. 25, 2007

(51) Int. Cl. G06Q 50/00

(52) U.S. Cl. 705/2

(57) ABSTRACT

Online processing system which combined the process of medical consultation and medical attention, prescription, and monitoring.

### BACKGROUND OF THE INVENTION

1. Field of the Invention

This invention consists of a processing system and methods that interconnect different stages of the doctor-patient consultation process in order to offer a consultation and prescription service online.

2. Description of the Prior Art

In order to receive medical attention right now, it is required to visit the doctor's office. Limited consultation can be obtained over the telephone. There are also web-sides with automated applications that can help determine an illness and/or a cause based on questions asked about symptoms. Although, there is a lack of personalized medical attention offered via internet. A visit to a doctor for most senior citizens with walking problems is difficult. People with disabilities or for whatever reason busy share this same problem. This system is developed to avoid or ease these difficulties. This system is developed to provide access to medical attention to those who find it difficult to obtain.

There are some patents more or less related to this invention. Typical of these are U.S. Pat. Nos. 6,978,268; 6,304,788; 7,107,106; 7,103,419; 7,096,072; 6,671,563. Although, these patents are related to the subject of this invention, none of them apply specifically to this invention.

### BRIEF SUMMARY OF THE PRESENT INVENTION

The patient would connect to a web page from his/her computer to the program or to a program installed on his/her computer. After verifying the authenticity of the patient, he/she would connect to a device that would take the vital signs and information pertaining to the patient's health. This program will send the information to the server. The information will then be transmitted from the server to the doctor if the patient wants a medical consult. Also, this same program can offer predetermined recommendations. The program, also known as web platform, can save the data for monitoring purposes and statistics about the condition. Once the doctor has issued a diagnosis, he can submit an online prescription. The prescription will be saved in the server and the patient can go to a pharmacy where the pharmacist would unload the prescription from the server. The same process can be used on branches related to the medical field for example, medical laboratories. Each of the areas involved in the total process has a specific program that would connect to the server.

### BRIEF DESCRIPTION OF THE DRAWN FIGURES

FIG. 1 Diagram of the system

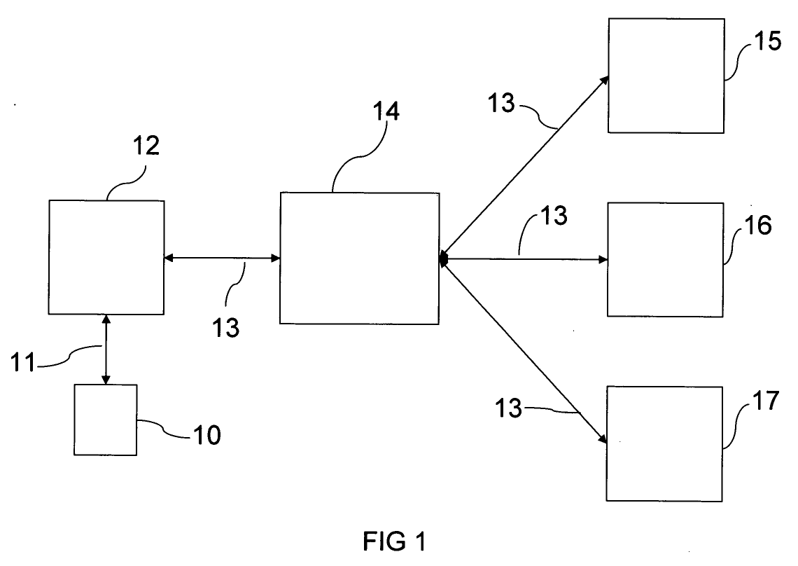

### DESCRIPTION OF THE REFERENCES NUMERALS

10. device that would obtained vital sings and other information pertaining to the patients health
11. communication between the device that obtained the vital signs and the medical program
12. medical program or web site that the patient uses for a consultation
13. communication between the program and the server that connects the programs, Internet
14. server with online consultation platform that connects the programs and saves the patient's data, medical records, and prescriptions among others.
15. program utilized by the doctor for the consultation, collection of data and recompilation of record among others.
16. program that the pharmacy utilizes to access the prescription and other information.
17. program utilized in laboratories to obtain laboratory orders etcetera.

### DETAILED DESCRIPTION OF THE PREFERRED EMBODIMENT

The patient would access the program (12) after identifying himself/herself, would connect to a device that takes the vital sings (10). This device communicates directly with the program (12). The communication method can be anything with access like USB, or Bluetooth among others. The program (12) would connect to a server (14) through the internet (13). The server (14) saves the data provided by the vital sings measure device (10). This data is also saved in the patient's computer through the program (12). The server (14) can provide information based on the obtained data about recommendations or analysis. It can also connect the patient with his/her doctor. The doctor that utilizes the program designed specifically for doctors (16), would connect to the server (14) via internet (13). He can receive information directly from the patient through the server (14) and is able to offer the consultation directly to the patient's program (12). Both ways of communication would be on real time. The consultation can also be issued at a later time. The communication between doctor and patient can be through voice, video, and or chat. The doctor can submit a prescription to the server (14). These will be saved on a database in the server (14) and would be access from the pharmacy. The pharmacy would utilize a specific program for pharmacies (16) that would allow the access to the patient's prescription. The prescription saved in the server (14) will expire at the time the pharmacy delivers the medication to the patient avoiding refills on it. Although, it will be registered on the record for medical history or other. The same process will be followed by laboratories that would utilize a specific program for laboratories (17). With a difference that the laboratory results would be saved on a server (14) where doctors can access them.

1. I claim an online system of process and methods that interconnect different stages of the doctor-patient consultation process.

2. The system of claim 1, wherein may include communication with pharmacies.

3. The system of claim 1, where in may include communication with laboratories.
